(19) United States
(12) Patent Application Publication
(10) Pub. No.: US 2002/0173371 A1
(43) Pub. Date: Nov. 21, 2002

(54) Method of manufacturing a molded grip

(76) Inventors: Robert E. Lamkin, Bonita, CA (US); Michael E. Lamkin, Chula Vista, CA (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/158,364

(22) Filed: May 29, 2002

Related U.S. Application Data
(62) Division of application No. 09/779,029, filed on Feb. 7, 2001.

(51) Int. Cl. A63B 53/14; B29C 51/00

(52) U.S. Cl. 473/300; 264/239

(57) ABSTRACT

A grip for a sporting implement includes an underlisting of an elastic material and in one embodiment a removable sleeve adapted to be releasably seated in an annular recess in the underlisting and in a second embodiment a material is molded into the annular recess of the underlisting and in both embodiments, any desired pattern can be formed in the outer surface of the grip and of any desired color.

### CROSS-REFERENCE TO RELATED APPLICATION

This application is a division of U.S. application Ser. No. 09/779,029, filed Feb. 7, 2001 and entitled “Grip For Sporting Implement.” U.S. application Ser. No. 09/779,029 is hereby incorporated by reference as though fully disclosed herein.

### BACKGROUND OF THE INVENTION

1. Field of the Invention

A grip for a sporting implement includes an underlisting adapted to be received on the handle of the sporting implement and a sleeve or molded body of material received on the underlisting.

2. Description of the Relevant Art

Grips for sporting implements have taken numerous forms over a long period of time with early grips for golf clubs, tennis rackets and the like simply consisting of a wrap of material, such as leather, in a helical pattern around the handle portion of the sporting implement. Through the years such wrap type grips became more sophisticated in that the leather, and in more recent times, polyurethane, which was wrapped around the handle of the sporting implement was wrapped onto an elastic underlisting which typically takes the form of vulcanized rubber. In the case of golf clubs, the underlisting is a hollow tubular body having an end cap that is adapted to be slid over the butt end of the golf club shaft and defines a seating area where a strip of leather or synthetic material can be wrapped about the underlisting. The underlisting, of course, gives a softer surface on which to wrap the leather or synthetic material thereby providing a different gripping relationship between an athlete and the sporting implement.

In the sport of golf, grips evolved from the wrap type grip to simply vulcanized rubber sleeves that were slipped over the butt end of the club but had the drawback of being worn fairly quickly so that the surface of the grip became slippery and undesirable from a performance standpoint. Such vulcanized rubber grips are still in use and utilize various recessed patterns on the surface thereof to improve the gripping surface. Another prevalent problem with conventional vulcanized rubber tubular grips resides in the fact that once the grip becomes slippery and is therefore undesirable from a performance standpoint, the entire grip must be replaced which is expensive and time consuming.

Wrap-type grips have always been used but are gaining increased popularity with the advent of alternative materials from which to form the strip of material that is wrapped about the underlisting. For example, polyurethanes have become a popular material for the strip of wrap material. One disadvantage with wrap materials resides in the manufacturing process which is fairly time consuming in that the strip of leather or synthetic material needs to be carefully wrapped onto an underlisting either prior to or after the underlisting has been mounted on the shaft of the sporting implement.

Accordingly, it would be desirable in the field of sporting equipment to provide a grip that can be replaced easily and quickly and/or a grip that simulates a wrap type grip that does not require the time consuming task of actually wrapping a strip of leather or synthetic material about an underlisting.

### SUMMARY OF THE INVENTION

The present invention relates to a grip utilizing an underlisting and in one embodiment a removable sleeve easily mountable and removable from the underlisting and in another embodiment a moldable material molded directly onto the underlisting.

In the first embodiment, an underlisting of tubular configuration and having an end cap adapted to abut the end of a sporting implement such as a golf club is provided with an annular recess that extends substantially from one end of the underlisting to the other end. A tubular sleeve is adapted to be removably seated in the annular recess and is retained in position by collars at opposite ends of the underlisting and by cooperating inhibitors provided in an external surface of the annular recessed area of the underlisting and an internal surface of the tubular sleeve. The inhibitors in a preferred embodiment consist of an annular bead on one of the underlisting or outer sleeve and a cooperating annular groove on the other of the underlisting or outer sleeve with the inhibitors cooperating with the collars at opposite ends of the underlisting in releasably securing the sleeve in position.

The outer surface of the tubular sleeve can include any form of recessed pattern to provide a desired gripping surface and further the sleeve as well as the underlisting can be made of any desired color to add variety to the features of the grip. Typically, the underlisting would be of a harder material than the tubular sleeve but could be made of the same material with the underlisting having a higher durometer rating than the tubular sleeve.

The second embodiment of the invention incorporates an underlisting defining a seating surface around its outer perimeter to which a body of material is directly molded. Desirably, the molded body surrounding the underlisting is softer than the underlisting material itself to provide a desired gripping surface while the underlisting provides the desired stability or base for the grip.

The grip can be manufactured by providing an underlisting into which a mandrel is inserted prior to placing the underlisting and mandrel combination in a mold having a cavity that substantially conforms with but is slightly larger than the outer dimension of the underlisting. The mold includes an injection passage so that the moldable material can be injected into the cavity around the mandrel reinforced underlisting until the material is molded to and forms a desired outer gripping surface for the grip.

The mold cavity could have any pattern formed therein so that the outer surface of the molded body of the grip is desirably textured to enhance the gripping features.

While a grip formed in accordance with the present invention would find use on numerous types of sporting implements, it will be described in connection with a golf club but the description is not intended to be limiting on the field of use of the grip.

Other aspects, features and details of the present invention can be more completely understood by reference to the following detailed description of a preferred embodiment, taken in conjunction with the drawings and from the appended claims.

### BRIEF DESCRIPTION OF THE DRAWINGS

FIG. 1 is an isometric view of a golf club incorporating a first embodiment of the grip of the present invention.

FIG. 2 is an enlarged, fragmentary isometric view showing the grip portion of the golf club illustrated in FIG. 1.

FIG. 3 is an exploded view of the grip incorporated onto the golf club of FIG. 1. FIG. 4 is a partially exploded isometric view showing the sleeve of the grip of FIG. 1 being slid upon the underlisting.

FIG. 5 is an isometric view of the assembled grip of FIG. 1 in alignment with the butt end of a golf club shaft on which the grip is to be mounted.

FIG. 6 is a section taken along line 6-6 of FIG. 2.

FIG. 7 is an enlarged fragmentary section taken along line 7-7 of FIG. 6.

FIG. 8 is an enlarged section taken along line 8-8 of FIG. 6.

FIG. 9 is an enlarged fragmentary section taken along line 9-9 of FIG. 6 .

FIG. 10 is an fragmentary section similar to FIG. 7 illustrating the butt end of the underlisting of the grip.

FIG. 11 is a fragmentary section similar to FIG. 9 showing the tip end of the underlisting.

FIG. 12 is a fragmentary section similar to FIG. 7 showing the butt end of the tubular sleeve.

FIG. 13 is a fragmentary section similar to FIG. 9 showing the tip end of the tubular sleeve.

FIG. 14 is an isometric view of one embodiment of the tubular sleeve of the grip of FIG. 1.

FIG. 15 is an isometric similar to FIG. 14 showing a second embodiment of the tubular sleeve.

FIG. 16 is an isometric similar to FIG. 14 showing still another embodiment of the tubular sleeve.

FIG. 17 is an isometric exploded view of a mold for forming the second embodiment of the present invention and with an underlisting shown displaced therefrom.

FIG. 18 is an isometric view of the mold of FIG. 17 shown in a closed position and with hidden components of the mold and the underlisting therein being shown in dashed lines.

FIG. 19 is a section taken along line 19-19 of FIG. 18.

FIG. 20 is a fragmentary isometric view of a grip formed with the mold illustrated in FIGS. 17-20 and with the grip mounted on a golf club shaft.

### DESCRIPTION OF THE PREFERRED EMBODIMENTS

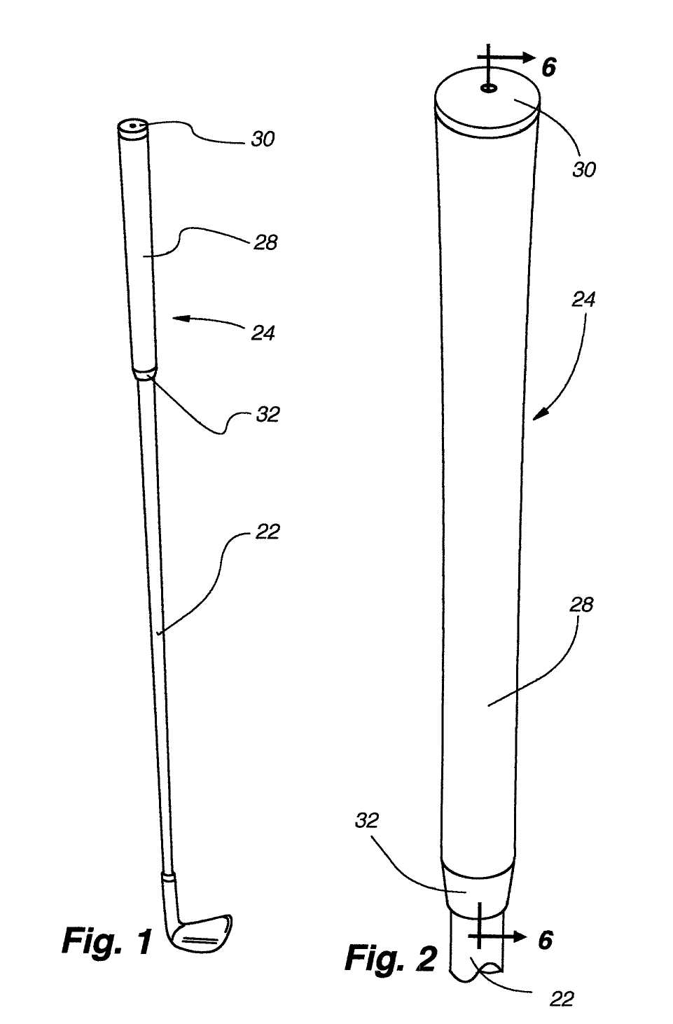

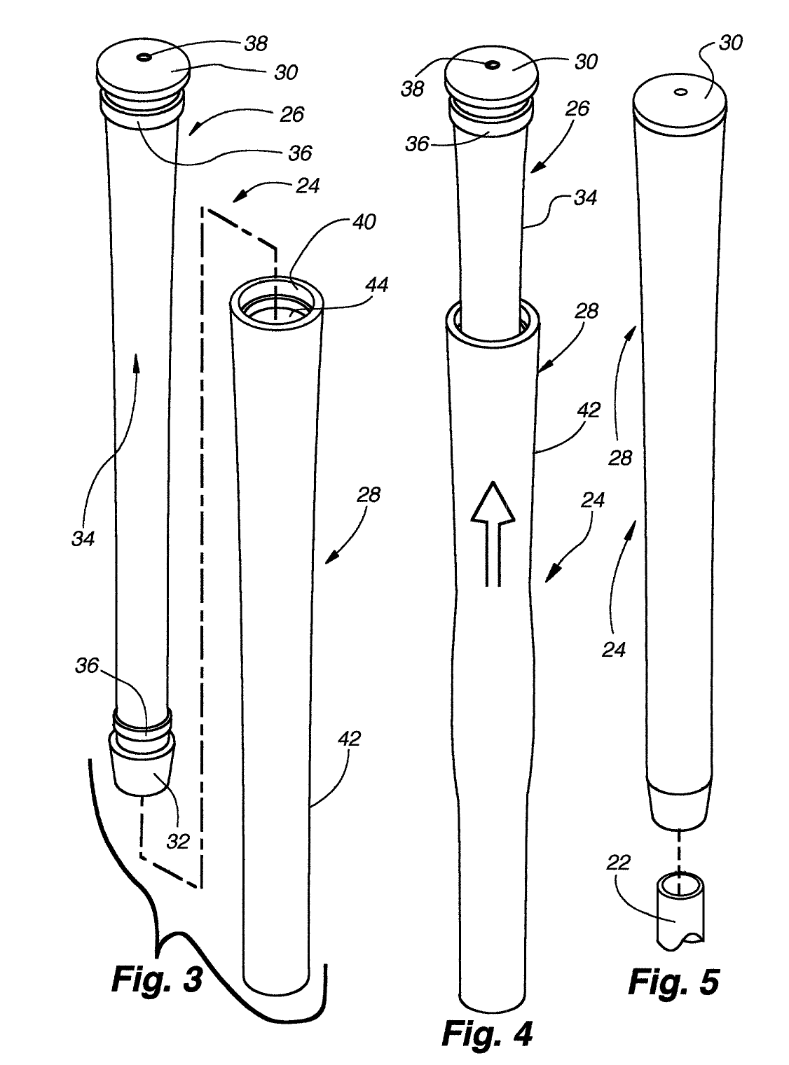

A golf club shaft 22 incorporating a first embodiment of the grip of the present invention is shown in FIGS. 1 and 2. The grip 24, which is possibly best seen in FIGS. 3-5 is a two-piece grip including an underlisting 26 and an outer tubular sleeve 28. As will be explained in more detail later, the outer sleeve 28 is adapted to be releasably seated on the underlisting 26 so that it can be replaced without replacing the underlisting to save time and expense in providing a new gripping surface for the club 22.

The underlisting 26 is an elongated tubular body made of an elastic material such as vulcanized or synthetic rubber. While the durometer rating of the rubber could be as desired for a particular application, it has been found that a durometer rating of 65 to 70 provides desirable results for a golf club. The underlisting is of hollow tubular construction having an axial recess 29 therein with the underlisting tapering slightly in a converging manner on both its inner and outer surfaces from a butt end to a tip end so as to conform with the taper of the golf club shaft. The taper of the outer surface can be varied as desired to vary the gripping surface of the grip as will become clear later. The underlisting has a collar 30 at the butt end of the club in the form of an end cap and a collar 32 at the tip end in the form of a tapered frustconical body. Between the end cap 30 and the tip collar 32 is an annular recessed region 34 defining a seating surface for the outer sleeve 28. An inhibitor in the form of an annular bead 36 is formed in the annular recessed area 34 immediately adjacent to the collars at the butt and tip end of the underlisting which, as will be explained later, cooperate with mating inhibitors on the outer sleeve 28 to assist in retaining the outer sleeve in the annular recess of the underlisting. A passageway 38 is provided through the end cap 30, as with most golf grips, which functions as a vent to facilitate mounting of the underlisting on the butt end of the golf club shaft 22.

The outer sleeve 28 is a tubular member that is also of somewhat tapered construction to conform with the taper on the underlisting 26. The outer sleeve has an inner generally cylindrical surface 40 that is of a diameter slightly less than the outer diameter of the annular recess 34 in the underlisting and is tapered in conformity with the taper of the annular recess 34 in the underlisting. The diameter of the outer surface 42 of the outer sleeve 28, or the gripping surface of the grip, conforms substantially to the diameter of the end cap 30 and the tip collar 32 of the underlisting, and the outer surface is tapered in conformity with the desired taper of the gripping surface of the grip. Adjacent to the butt end and the tip end of the outer sleeve, an annular groove 44 is provided in the inner surface 40 that is adapted to mate with the annular beads 36 on the underlisting 26 so that when the outer sleeve is seated in the annular recess of the underlisting, the annular beads 36 are retained within the annular grooves 44 to inhibit movement of the outer sleeve. The outer sleeve can be made of any suitable material but a vulcanized or synthetic rubber has been found suitable. Further, while the durometer rating of the outer sleeve could be in any desirable range for the purpose intended, for a golf club a durometer rating in the range of 35 to 40 has been found desirable.

When assembling the grip 24 on a golf club, the outer sleeve 28 is first advanced over the butt end of the golf club shaft 22 with the tip end leading as the sleeve is slid over the butt end of the shaft. The sleeve is advanced far enough along the shaft so that the underlisting 26 can next be mounted on the butt end of the shaft in a conventional manner without interference from the sleeve. A double-faced adhesive tape or the like (not shown) is preferably placed around the butt end of the shaft and a solvent exposed thereto prior to mounting the underlisting so that the underlisting can be easily slid onto the shaft in a conventional manner and be gripped by the adhesive once the solvent has evaporated.

With the underlisting 26 mounted on the butt end of the shaft 22 so that the end cap 30 abuts the butt end of the shaft, the outer sleeve 28 is slid upwardly as illustrated in FIG. 4 onto the underlisting until the outer sleeve is seated within the annular recess 34 of the underlisting with the annular grooves 44 receiving and mating with the annular beads 36.

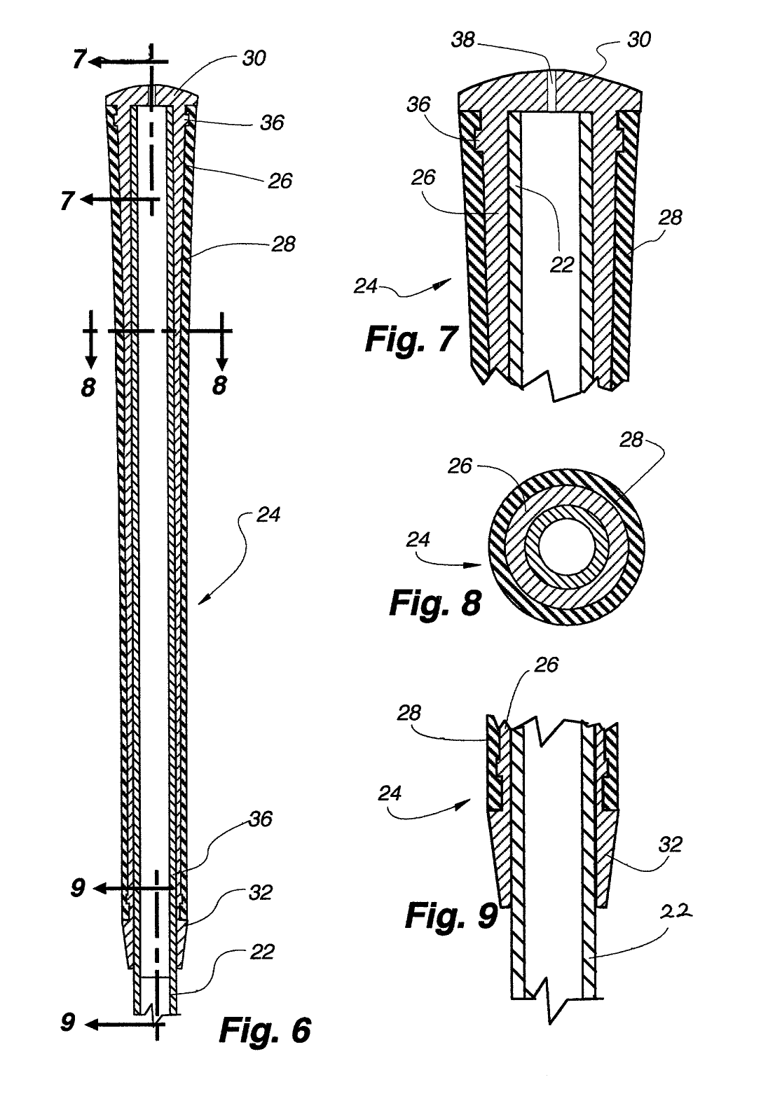

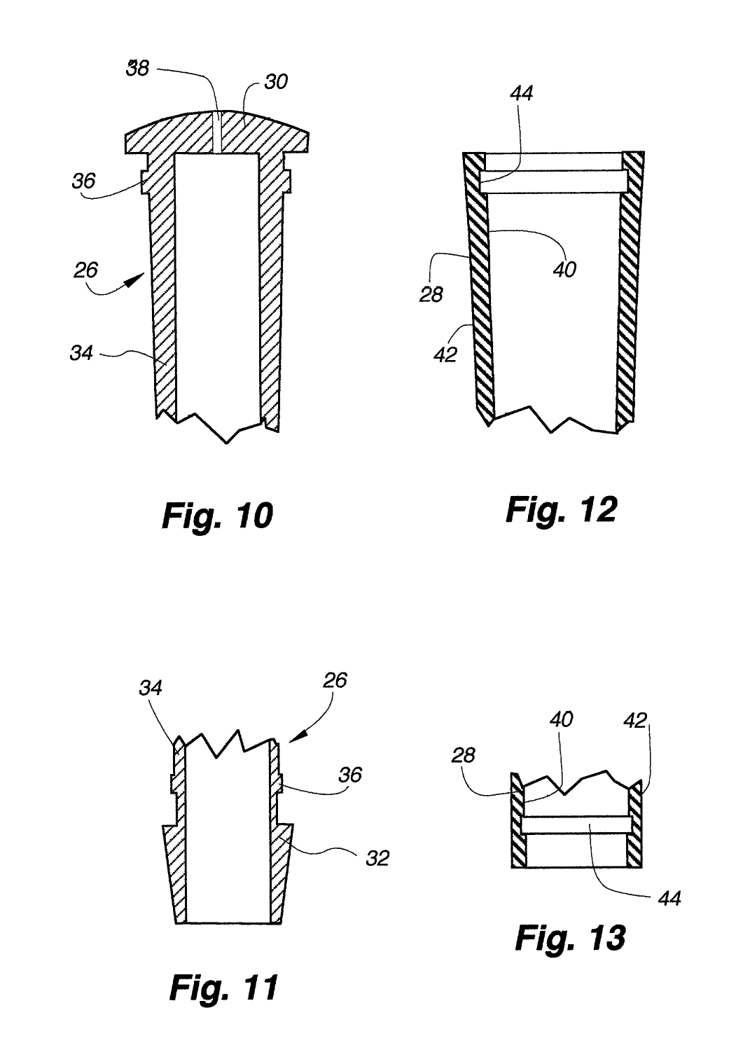

The outer sleeve 28 is shown fully mounted on the underlisting 26 in FIGS. 6-9 with FIGS. 7-9 being cross-sectional views illustrating the relationship of the outer sleeve to the underlisting and the underlisting to the shaft 22 of the golf club.

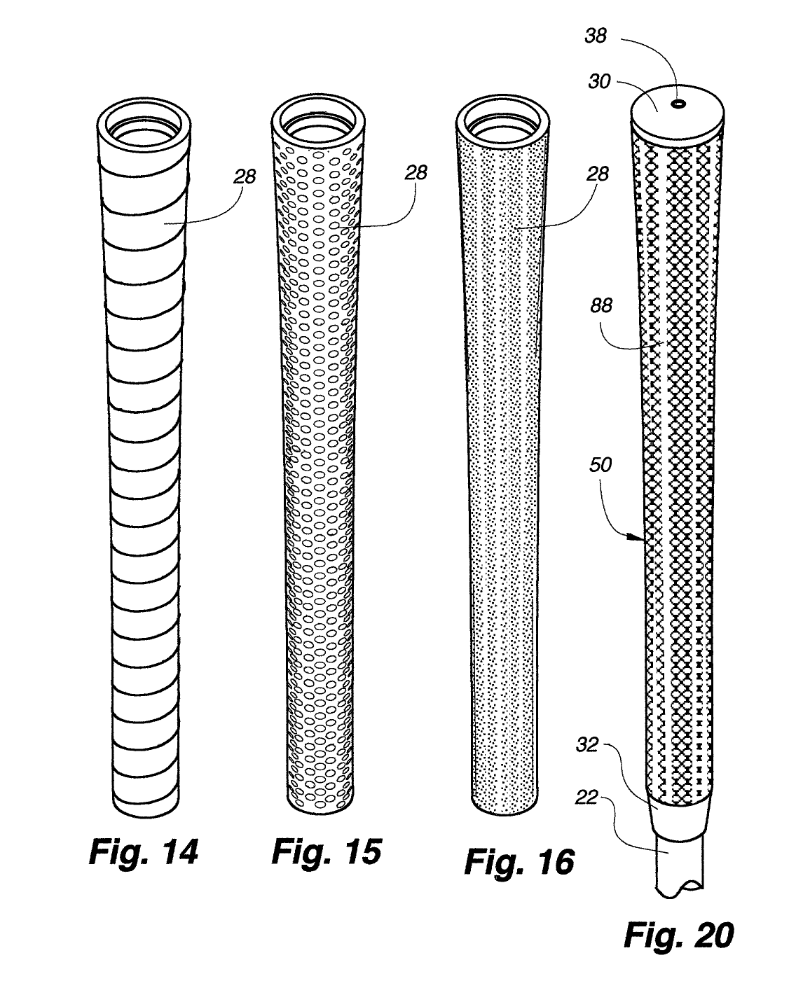

FIGS. 14-16 illustrate various surface finishes for the outer sleeve 28 and as will be appreciated, the outer surface can be preformed in a molding process to simulate a wrap type grip as in FIG. 14, a dimpled pattern as in FIG. 15, or a stippled pattern as in FIG. 16. Any desired pattern can be molded into the outer surface of the sleeve as would be within the skill of those in the art.

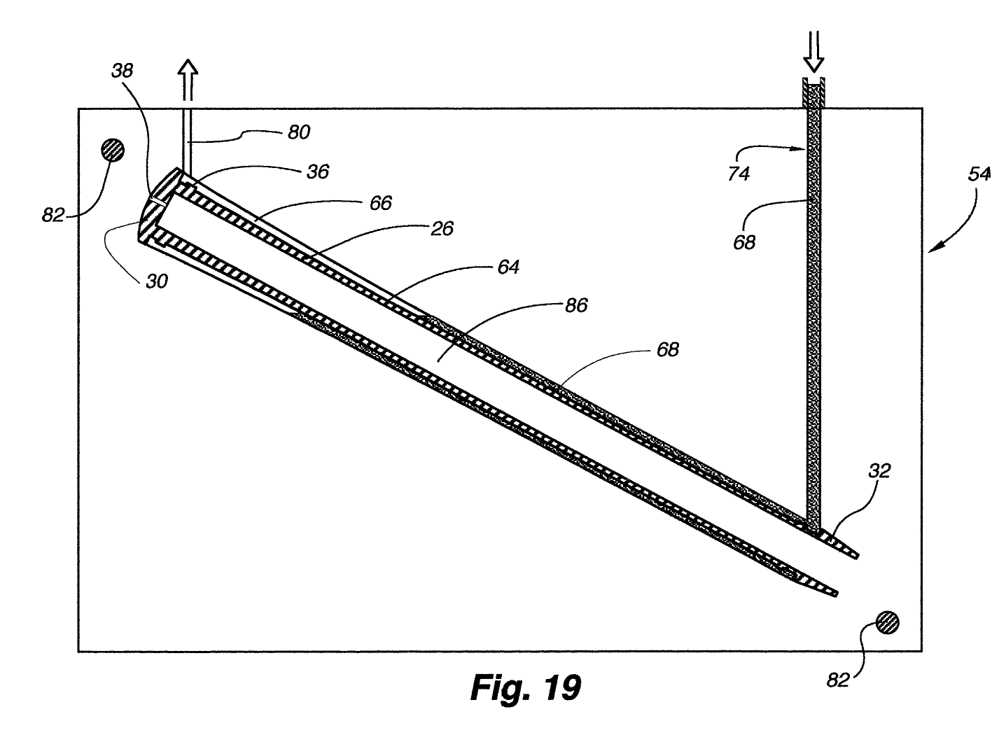

The second embodiment 50 (FIGS. 19 and 20) of the grip of the present invention consists of an underlisting 26 of the type described previously, which may or may not include the annular beads 36. For purposes of the present disclosure, the underlisting 26 has been shown to be identical to that previously described but underlistings of other configurations could be utilized.

In forming the second embodiment of the grip of the present invention, a mold 54 is provided having upper and lower halves 56 and 58, respectively, with confronting faces 60 with cavities 62 defined therein. The cavities are positioned so as to be confronting when the mold halves are positioned in face to face confronting relationship to define a joined cavity 63. Accordingly, each cavity is of substantially semicylindrical configuration so that when they are in confronting relationship, the joined cavity 63 conforms with a finished grip 50 and is adapted to receive and seat an underlisting 26 prior to a molding process. It will therefore be appreciated that the completed or joined cavity formed from the cavities 62 in the two mold halves 56 and 58 are slightly larger in configuration than the underlisting 26 with the joined cavity conforming precisely at tip and butt ends to the tip collar 32 of the underlisting and the end cap 30, respectively. The joined cavity 63 is formed to be slightly larger than the annular recess 34 in the underlisting so that when the underlisting is positioned in the joined cavity 63, an annular space 66 is defined between the annular recess 34 and the walls of the joined cavity. A moldable material 68 can be injected into the annular space 66.

Each mold half has half of an injection passage 70 formed therein and with one half passage 72 adapted to confront a corresponding half passage 74 in the other mold half so that the moldable material 68 can be injected into the cavity 63 through the injection passage 70 when the underlisting 26 is positioned therein. As is conventional in injection molding, a vent passage 76 is also defined by two vent passage halves 78 and 80 in each of the mold halves 56 and 58, respectively, that communicates with an opposite end of the joined cavity 63 from the injection passage 70.

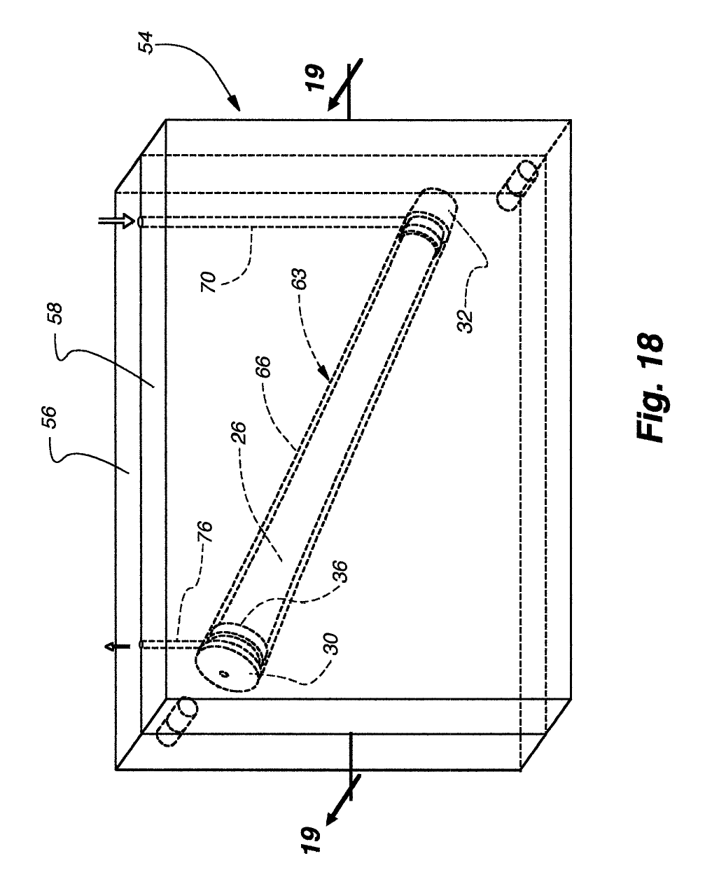

The mold halves include alignment pins 82 and holes 84 so that when the halves are placed in face to face relationship as shown in FIG. 18, the cavity and passage halves are confronting.

Prior to molding, a cylindrical mandrel 86 is positioned in the hollow interior of the underlisting 26 to support the underlisting, and the underlisting is then positioned within the cavity 62 on one half of the mold. The other half of the mold is then positioned in confronting relationship as shown in FIG. 18, and the mold halves clamped or otherwise held together. With the mold halves clamped together, the underlisting is confined within the joined cavity 63 and held in position so as to define the annular gap 66 around the annular recess 34 in the underlisting. The moldable material 68 is thereafter injected into the mold through the injection passage 70 and allowed to flow into the annular gap as air in the annular gap is vented through the vent passage 76. Once the entire annular gap 66 has been filled with the moldable material, the injection of the moldable material is terminated and the moldable material allowed to cure. The movement of the moldable material 68 from the injection passage 70 toward the vent passage 76 is illustrated in FIG. 19.

After the moldable material has cured, the mold halves 56 and 58 are separated and the completed grip 50 removed from the mold. Finally, the mandrel 86 is removed from the underlisting 26.

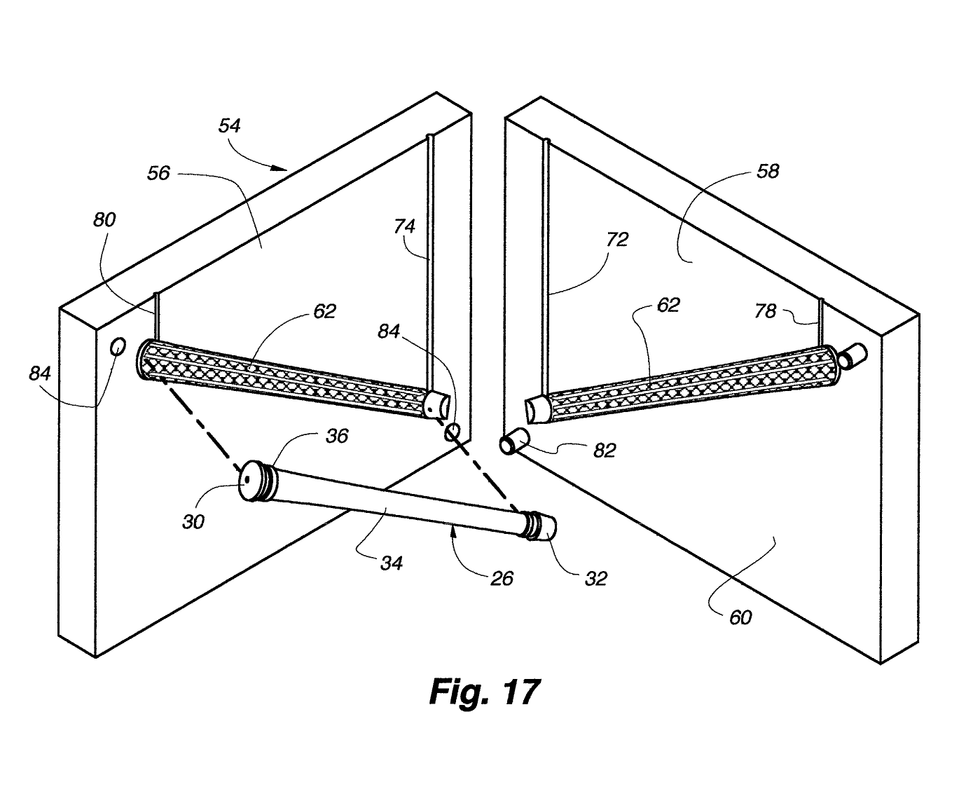

A recessed pattern (FIG. 17) can be provided in each cavity of the mold halves to define a desired recessed pattern for the outer surface of the molded body 88 (FIG. 20) of the grip. Of course, the pattern can be any desired pattern including those illustrated in FIGS. 14-16.

The underlisting 26 for the molded grip could, as described previously, be a vulcanized or synthetic rubber and while the durometer rating of the rubber could be chosen for a selected use, for golf club grips, a durometer rating in the range of 65 to 70 has been found desirable. The moldable material 68 could be any suitable material but a polyurethane material has been found desirable. The polyurethane could take on various desired characteristics depending upon the intended use but a polyurethane having a durometer rating in the range of 35 to 40 has shown to be desirable.

Although the present invention has been described with a certain degree of particularity, it is understood that the present disclosure has been made by way of example, and changes in detail or structure may be made without departing from the spirit of the invention as defined in the appended claims.

We claim:

1. A method of manufacturing a grip for a sporting implement comprising the steps of:
forming a tubular underlisting of an elastic material defining a hollow core,
placing a mandrel in the hollow core,
forming a mold having a cavity therein of slightly larger dimension than said tubular underlisting and with a passageway for injecting a moldable material into said cavity,
placing the tubular underlisting with the mandrel in the cavity, and
injecting a moldable material into the cavity to form an annular body of said moldable material around said tubular underlisting.

2. The method of claim 1 wherein the moldable material is polyurethane.

3. The method of claim 1 wherein said cavity has a recessed pattern formed in the walls thereof so that the pattern is molded into said annular body.

4. The method of claim 1 wherein said mold is a two-piece mold.

5. The method of claim 1 wherein said tubular underlisting is formed with an annular recess and said moldable material is injected into the mold so as only to occupy said annular recess.
